(19) United States
(12) Patent Application Publication
(10) Pub. No.: US 2023/0397766 A1
(43) Pub. Date: Dec. 14, 2023

(54) DEVICE FOR FRYING AND/OR BAKING FOOD TO BE FRIED

(71) Applicant: Roman STEINER, Kirchdorf-Tirol (AT)

(72) Inventor: Roman STEINER, Kirchdorf-Tirol (AT)

(21) Appl. No.: 18/246,444

(22) PCT Filed: Sep. 2, 2021
(86) PCT No.: PCT/EP2021/074217

§ 371 Date: Mar. 23, 2023

(30) Foreign Application Priority Data
Sep. 24, 2020 (DE) 10 2020 124 926.8

(51) Int. Cl. A47J 37/12

(52) U.S. Cl. CPC A47J 37/1295

(57) ABSTRACT

The invention relates to a device for frying and/or baking food comprising a pan, a heating element and an insert for receiving food to be fried, the insert comprising a plurality of separating devices adapted and arranged to fry a plurality of pieces of food to be fried separately from each other. The invention further comprises a corresponding insert and a method for frying and/or baking food to be fried.

The invention relates to an apparatus for frying and/or baking food comprising a pan, a heating element and an insert for receiving food to be fried, the insert comprising a plurality of separating devices suitable and intended for cooking a plurality of pieces of food to be fried separately from each other. The invention further comprises a corresponding insert and a method for frying and/or baking food.

### STATE OF THE ART

Devices for deep-frying food, especially for household and gastronomy, are known. Larger dimensioned foods, e.g. cutlets and fish, can only be deep-fried one piece at a time in such devices, as they would otherwise stick together and any existing breading would be destroyed.

In the industrial production of food, deep-frying using the assembly line method is well known. Especially for the catering industry, but also for household applications, such appliances are too large and therefore too expensive and too time-consuming to maintain. Such appliances are to be used most effectively in continuous operation.

It is therefore the objective of the present invention to provide a device for frying and/or baking food to be fried, in particular for the catering industry, which features effective and inexpensive operation.

It is also an object of the present invention to provide, in particular for the catering industry, a method for frying food to be fried, with which effective and inexpensive operation is possible.

The objective is solved by means of the device for frying and/or baking food to be fried according to claim 1. Advantageous embodiments of the invention are set out in subclaims 2 to 11.

The device according to the invention for frying and/or deep-frying food has a pan for holding the frying medium. The frying medium is usually a liquid frying fat or deep-frying fat with a high smoking point. A heating element is used to heat the frying medium. The insert holds the food to be fried. According to the invention, the insert comprises one or more separating devices. By means of the separating devices, several pieces of food can advantageously be fried in the frying medium (fat or oil) at the same time, spatially separated from each other. During the frying process, a user can fill another insert of the same design with food to be fried. This increases the number of pieces of food that can be fried per unit of time. At the same time, the device requires little space and comprises low purchase and maintenance costs. In an optional embodiment, the food is completely submerged in the frying medium during frying.

In a further embodiment of the invention, directly adjacent separating devices comprise an intermediate space. The intermediate space is larger than the thickness of the food to be fried in order to be able to safely fill the insert with the food to be fried.

In a further development of the invention, the intermediate space is at least 0.5 mm, preferably 1 cm. Cutlets, in particular Wiener schnitzels, comprise a thickness of 0.3 cm to 0.7 cm. An intermediate space of 1 cm and larger ensures that such a food to be fried can be inserted and positioned between two separating devices.

In another embodiment of the invention, two adjacent separating devices form a receptacle for the food to be fried. Two separating devices are arranged in such a way that one separating device forms the base and the separating device arranged above it forms a lid.

The food to be fried is therefore also fixed between the two adjacent separating devices during the frying process.

In a further embodiment of the invention, the separating device comprises a base. The base is flat and level. The base of the separator holds the food to be fried.

In another embodiment of the invention, the base of a separating device comprises an opening. The opening is suitable and intended for allowing a frying medium to flow through during the frying process. The frying medium is set in motion by convection (circulation) and/or a stirring device during the frying process, in particular to ensure a uniform temperature distribution within the pan. The opening allows the frying medium to flow through unhindered, even between the individual separators.

In another embodiment of the invention, the base is arranged horizontally. Due to the horizontal arrangement of the base, the food to be fried is held in position on the separating device by the force of gravity, therefore further fixing elements for the food to be fried are not necessary.

In a further development of the invention, the separating devices are arranged parallel to each other and/or one below the other. Two separating devices are arranged in such a way that one separating device forms the base and the separating device arranged above it forms a lid and thus keeps the food to be fried in position even during the frying process.

In a further embodiment of the invention, the separating devices are connected to each other via a bar. The bar holds the separating devices in position and also prevents the separating devices from moving during the frying process. The separating devices are non-detachably connected to the bar, e.g. by means of welding or riveting. Detachable connections are possible e.g. by screwing.

In a further embodiment of the invention, the separating device comprises an elevation. The elevation prevents the food to be fried from changing position during the frying process.

In a further development of the invention, the elevation is arranged at the rim of the separating device. The elevation prevents the food to be fried from changing position during the frying process. Positioning at the rim of the separating device enables optimal utilisation of the space of the separating device by holding food to be fried.

The objective is further fulfilled by the insert according to the invention for receiving food to be fried according to claim 12.

The insert according to the invention for receiving food to be fried is suitable and intended to be inserted or immersed in a device filled with a frying medium for frying and/or baking food to be fried. Depending on the dimensions of the insert, the insert can be used in conventional, already known devices for frying and/or baking food to be fried. High purchase costs for the device are therefore eliminated, and the operating costs due to the frying of several foods to be fried per frying process are lower than with known devices.

The objective is further fulfilled by the method according to the invention for frying food to be fried according to claim 13. Advantageous embodiments of the invention are set out in subclaims 14 to 17.

The method for frying food according to the invention comprises three method steps: In the first method step, one or more receptacles of an insert for food to be fried are filled with food to be fried. The receptacles are formed by separating devices. In the second method steps, the filled insert is immersed in a frying medium. In the third method steps, the food to be fried is fried in the frying medium. In an optional embodiment, the food to be fried is completely submerged in the frying medium during frying.

Due to the multiple receptacles for food to be fried, several pieces of food can be fried during the frying process without the food touching each other. This is particularly important for dishes that comprise breading, e.g. schnitzel or fried fish. The breading remains intact, the gravy is trapped in the food to be fried, and the inside of the food remains juicy. At the same time, the operating costs are lower due to the frying of several foods to be fried per frying process.

In a further embodiment of the invention, filling is carried out by loosely placing the food to be fried on the separating devices. The food to be fried does not require separate fixing elements to keep the food in position even during the frying process.

In a further embodiment of the invention, the insert is immersed with the food to be fried loosely placed on the separating devices. The insert can be immersed by hand by a user or by means of a motorised device for lowering or raising the insert.

In an advantageous embodiment of the invention, the food to be fried is completely surrounded by the frying medium during frying. The food to be fried is therefore thoroughly fried on all sides, any breading present enclose the juices present in the food to be fried, and the food remains juicy inside.

In another advantageous embodiment of the invention, the food to be fried completely loses contact with a separating device at least temporarily during the frying process. Due to convection of the frying medium and, if applicable, an existing stirring device, there is a flow in the frying medium that is directed in such a way that the food to be fried is lifted by the separating device. This effect is further enhanced by the openings arranged in the separating device. The heat of the frying medium therefore acts on the food to be fried from all sides in such a way that the juices present in the food to be fried cannot escape from the breading of the food to be fried, so the food to be fried remains juicy inside. In addition, the breading does not adhere to the food to be fried or does not adhere completely to the food to be fried, so it rises a little and forms waves, the breading “souffles”. This souffled breading is a quality feature of Wiener Schnitzel in particular.

Examples of embodiments of the device according to the invention for frying and/or baking food to be fried and of the method according to the invention for frying and/or baking food to be fried are shown schematically in simplified form in the drawings and are explained in more detail in the following description.

SHOWING:

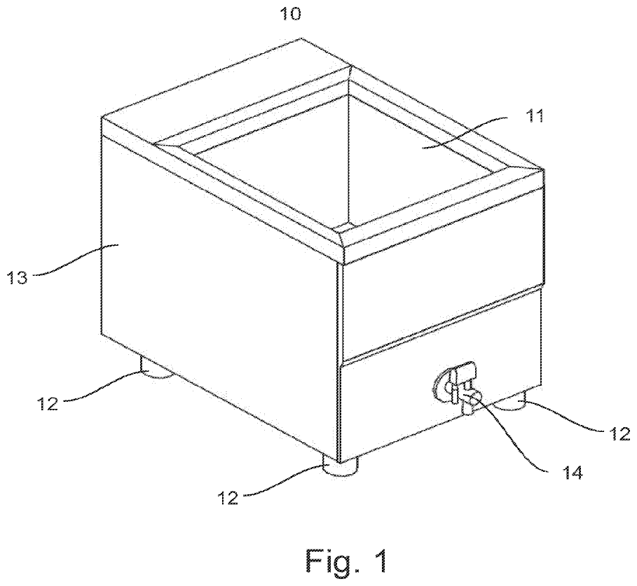

FIG. 1: A perspective view of an embodiment of the pan according to the invention

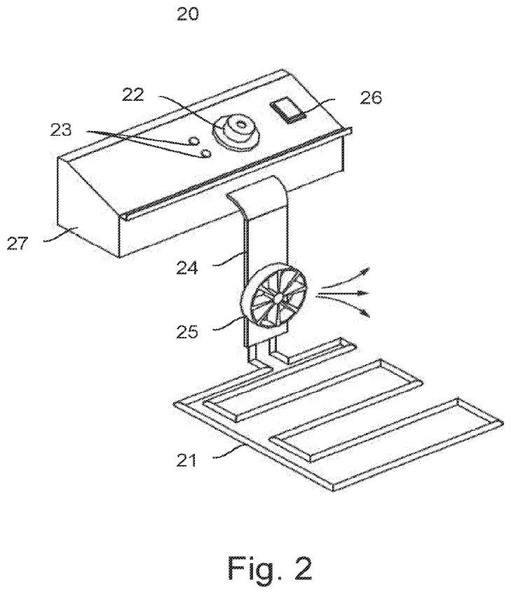

FIG. 2: A perspective view of an embodiment of the heating element according to the invention

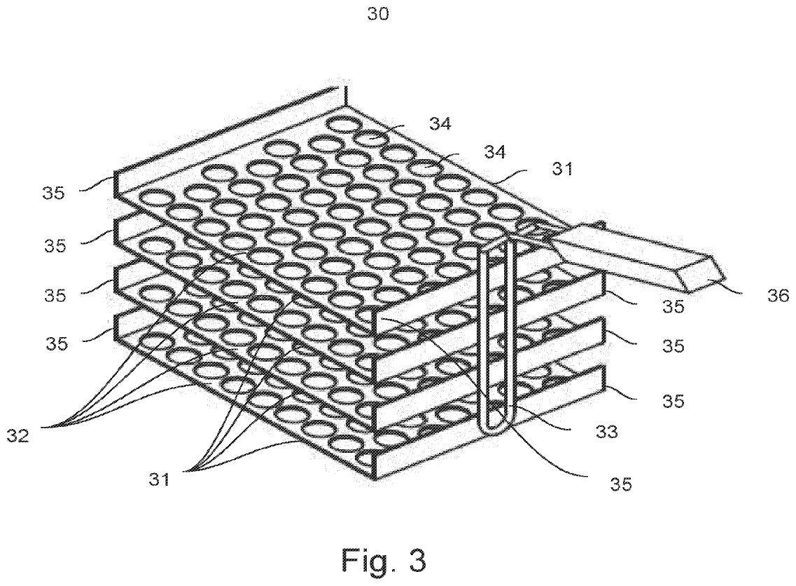

FIG. 3: A perspective view of an embodiment of the insert according to the invention

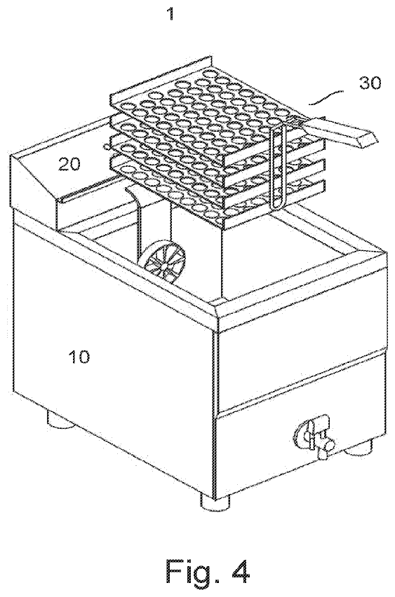

FIG. 4: A perspective view of an embodiment of the device according to the invention for frying and/or baking food to be fried

FIG. 1 shows a perspective view of an embodiment of the pan 10 according to the invention. The pan 10 according to the invention comprises the basin 11 for receiving the frying medium, e.g. a frying oil. The basin 11 is made of a temperature-resistant, food-hygienic and stainless material, for example a stainless steel. Therefore, the basin 11 is easy to clean even after use. The basin 11 itself is arranged in a housing 13, which comprises four support feet 12 to increase stability. Thermal insulation is positioned between basin 11 and the outer wall of housing 13 to prevent injury to a user from burns due to the frying medium heated during the frying process. A drain 14 for the frying medium is also positioned at the front, which can be closed by means of a tap.

For frying food to be fried, the basin 11 is filled with usually a frying oil. In the first method steps for frying food to be fried, an insert 30 (not shown) is filled with the food to be fried. In the next method steps, the filled insert 30 is immersed in the basin 11 filled with the frying medium in such a way that the food to be fried is completely covered with the frying medium. In the last method steps, the food to be fried is fried.

A perspective view of an embodiment example of the heating element 20 according to the invention is shown in FIG. 2. The heating element 20 comprises a heater 21, which is an electric resistance heater in this embodiment. However, another type of heat generation is also possible, for example a gas heater. The heater 21 is connected to the control unit 27 via the connecting element 24. The connecting element 24 comprises a stirring device 25, with which the frying medium is distributed during the frying process in such a way that the temperature distribution in the frying medium is as homogeneous as possible. The control unit 27 itself comprises an on/off switch 26, a temperature controller 22 for setting the temperature of the frying medium by a user, and indicator lights 23 for checking the proper functioning of the heating element 20. The heating element 20 is intended and suitable to be placed on the pan 10 (see FIG. 1) in such a way that the heating rods of the heater 21 are arranged on the base of the pan 11, while the control unit 27 is arranged on top of the pan 10 (see FIG. 4).

For frying food to be fried, the basin 11 is filled with usually a frying oil. In the first method step for frying food to be fried, an insert 30 (not shown) is filled with the food to be fried. In the next method step, the filled insert 30 is immersed in the basin 11 filled with the frying medium in such a way that the food to be fried is completely covered with the frying medium. In the last method step, the food to be fried is fried. By means of the temperature controller 22, the temperature of the frying medium is adjusted in such a way that the food to be fried is fried thoroughly, but at the same time the formation of harmful substances, in particular acrylamides, is largely avoided.

FIG. 3 shows a perspective view of an embodiment of the insert 30 according to the invention. In this embodiment, the food to be fried is schnitzel, in particular Wiener schnitzel. In this embodiment, the insert 30 according to the invention comprises four separating devices 31 of identical construction, which are arranged parallel to one another. According to the invention, however, the number of separating devices 31 is not limited, the possible number of separating devices 31 being determined only by the dimensions of the basin 11. The distance between the separating devices 31 is greater than the food to be fried. The thickness of cutlets, in particular Wiener schnitzels, is usually 0.3 cm to 0.7 cm, the distance between the separating devices 31 is therefore advantageously at least 1 cm.

The base 32 of a separating device 31 is flat and designed to hold the cutlets. An elevation 35 is arranged on each of two opposite rims of a separating device 31 to prevent the food to be fried from moving sideways during the frying process. The base 32 comprises a plurality of openings 34. The separating devices 31 are attached to the bar 33 by means of welding. Other fastening options include soldering, screwing or riveting. The bar 33 also comprises the thermally insulated handle 36, by means, of which the insert 30 can be lifted and transported by a user, in particular moved into or out of the pan 11.

To fry a food to be fried, the insert 30 is filled with the cutlets. Depending on the dimensions of the separating devices 31, a user places one or more cutlets loosely on each separating device 31. The separating device 31 on the top of the insert 30 is not filled with the food to be fried. During the frying process, this uppermost separating device 31 merely prevents the cutlet, which is located on the separating device 31 below it, from floating. In the next method step, the filled insert 30 is immersed in the basin 11 filled with the frying medium in such a way that the food to be fried is completely covered with the frying medium. In the last method step, the food to be fried is fried.

The number and dimensions of the openings 34 ensure that the cutlets are lifted during the frying process due to the convection currents of the frying medium in such a way that the cutlets lose contact with the base 32 of the separating device 31, in other words the cutlets are arranged in the frying medium in such a way that the cutlets have no contact with the separating device 31, on which the cutlets were placed by a user before the frying process, nor with a separating device 31 arranged above it. The heat of the frying medium thus acts on the cutlet from all sides in such a way that the gravy present in the meat cannot escape from the breading of the cutlet, the cutlets therefore remains juicy. In addition, the breading does not or not completely adhere to the cutlets during the frying process, so it rises a little and forms waves, the breading “souffles”. This “souffle” of the breading is a quality feature of a Wiener schnitzel.

Advantageously, a user can fill a further insert 30 of identical construction with cutlets or food to be fried during the frying process. The insert 30 according to the invention therefore not only enables a better frying result of a single cutlet, but also an increased number of fried cutlets per time unit with a low space requirement and low acquisition and operating costs of the device 1 according to the invention.

A perspective view of an embodiment of the device 1 for frying and/or baking food according to the invention is shown in FIG. 4. The device 1 comprises the pan 10 with basin 11 for receiving the frying medium (see FIG. 1). The heating element 20 is placed on the pan 10 in such a way that the heating rods of the heater 21 are arranged on the base of the basin 11, while the control unit 27 is arranged on the pan 10 (see FIG. 2). The insert 30 with four separating devices 31 is used to hold the food to be fried.

For frying food to be fried, the basin 11 is filled with the frying medium. In the first method step for frying food, the insert 30 is filled with the food to be fried, with the exception of the uppermost separating device 31. In the next method step, the filled insert 30 is dipped into the basin 11 filled with the frying medium in such a way that the food to be fried is completely covered with the frying medium. In the last method step, the food to be fried is fried. During the frying process, the food to be fried is lifted due to the convection currents of the frying medium in such a way that the food to be fried at least temporarily loses contact with the base 32 of the separating device 31. During the frying process, a user can fill another insert 30 of identical construction with food to be fried.

### REFERENCE LIST

1 Device for frying and/or baking food to be fried
10 Pan
11 Basin
12 Support feet
13 Housing
14 Drain
20 Heating element
21 Heater
22 Temperature controller
23 Indicator lights
24 Connecting element
25 Stirring device
26 On/off switch
27 Control unit
30 Insert
31 Separating device
32 Base
33 Bar
34 Opening
35 Elevation
36 Handle
100 Food to be fried

1. Device (1) for frying and/or baking food to be fried comprising:
a pan (10)
a heating element (20)
an insert (30) to hold food to be fried
characterised in that
the insert (30) comprises one or more separating devices (31) suitable and intended for frying several pieces of food to be fried separately from each other.

2. Device (1) for frying and/or baking food to be fried according to claim 1,
characterised in that
immediately adjacent separating devices (31) comprise an intermediate space, the intermediate space being greater than the thickness of the food to be fried.

3. Device (1) for frying and/or baking food to be fried according to claim 1,
characterised in that
the intermediate space measures at least 1 cm.

4. Device (1) for frying and/or baking food to be fried according to claim 1,
characterised in that
two adjacent separating devices (31) form a receptacle for food to be fried.

5. Device (1) for frying and/or baking food to be fried according to claim 1,
characterised in that
a separating device (31) comprises a base (32),
wherein the base (32) is flat and level.

6. Device (1) for frying and/or baking food to be fried according to claim 5
characterised in that
the base (32) of a separating device (31) comprises an opening (34),
wherein the opening (34) being suitable and intended to allow a frying medium to flow through it during the frying process.

7. Device (1) for frying and/or baking food to be fried according to claim 5,
characterised in that
the base (32) is arranged horizontally.

8. Device (1) for frying and/or baking food to be fried according to claim 1,
characterised in that
the separating devices (31) are arranged in parallel and/or one below the other.

9. Device (1) for frying and/or baking food to be fried according to claim 1,
characterised in that
the separating devices (31) are connected to each other via a bar (33).

10. Device (1) for frying and/or baking food to be fried according to claim 1,
characterised in that
the separating device (31) comprises an elevation (35).

11. Device (1) for frying and/or baking food to be fried according to claim 10
characterised in that
the elevation (35) is arranged at the rim of the separating device (31).

12. Insert (30) for receiving food to be fried, which is suitable and intended to be immersed in a device (1) filled with a frying medium for frying and/or baking food to be fried, according to claim 1.

13. Method for frying and/or baking food to be fried, comprising the following method steps:
Filling receptacles of an insert (30) for food to be fried, wherein the insert (30) comprises a plurality of receptacles, the receptacles being formed by separating devices (31)
Immersion of the filled insert (30) in a frying medium
Frying the food to be fried in the frying medium.

14. Method for frying and/or baking food to be fried according to claim 13,
characterised in that
filling is done by loosely placing the food to be fried on the separating devices (31).

15. Method for frying and/or baking food to be fried according to claim 13,
characterised in that
immersing takes place with the food to be fried placed loosely on the separating devices (31).

16. Method for frying and/or baking food to be fried according to claim 13,
characterised in that
during frying, the food to be fried is completely surrounded by the frying medium.

17. Method for frying and/or baking food to be fried according to claim 13,
characterised in that
the food to be fried completely loses contact with a separating device (31) at least temporarily during frying.
